(19) United States
(12) Patent Application Publication
(10) Pub. No.: US 2025/0316004 A1
(43) Pub. Date: Oct. 9, 2025

(54) METHOD AND APPARATUS PROCESSING VISUAL MEDIA

(71) Applicant: Samsung Electronics Co., Ltd., Suwon-si (KR)

(72) Inventors: Juan Raphael S SENA, Muntinlupa (PH); Amielle B DULAY, Sta. Rosa (PH); Manuel Antonio P RUFINO, Biñan (PH); Luis Miguel FLORES, North Caloocan (PH)

(21) Appl. No.: 19/227,981

(22) Filed: Jun. 4, 2025

Related U.S. Application Data
(63) Continuation of application No. PCT/KR2023/020019, filed on Dec. 6, 2023.

(30) Foreign Application Priority Data
Dec. 12, 2022 (PH) 1-2022-050619

(51) Int. Cl. G06T 11/60; G06T 7/11; G06T 7/13; G06V 10/40; G06V 40/16

(52) U.S. Cl. CPC G06T 11/60; G06T 7/11; G06T 7/13; G06V 10/40; G06V 40/161; G06T 2207/20132

(57) ABSTRACT

An apparatus and a method for processing an image are provided. The method includes obtaining one or more frames from at least one input visual media, for at least one frame of the one or more frames, detecting one or more features from the at least one frame based on feature detection model, determining at least one cropping window based on the one or more detected features and information regarding an aspect ratio of a display, obtaining one or more cropped frames based on the at least one cropping window, selecting one or more overlays based on one or more cropped out features, text, picture-in-picture display, and spaces left in the display, and generating one or more reframed frames by situating one or more selected overlays on the one or more cropped frame.

### CROSS-REFERENCE TO RELATED APPLICATION(S)

This application is a continuation application, claiming priority under 35 U.S.C. § 365 (c), of an International application No. PCT/KR2023/020019, filed on Dec. 6, 2023, which is based on and claims the benefit of a Philippines patent application number 1-2022-050619, filed on Dec. 12, 2022, in the Intellectual Property Office of the Philippines, the disclosure of which is incorporated by reference herein in its entirety.

### BACKGROUND

### 1. Field

The disclosure relates to a system and method processing visual media. More particularly, the disclosure relates to a system that is used for context-aware visual media reframing for variable resolution displays.

### 2. Description of Related Art

With a fast-paced world, media consumers have been frequenting different platforms and devices to keep tabs on all forms of visual content, such as news, sports, movies, and television series. With its offered convenience, mobile phone is one of the most used digital devices. These devices come in different form factors, such as foldables and rollables.

As the form factors implement varying display sizes and aspect ratios, users have long relied on the default viewing settings provided by their cutting-edge mobile devices. Among the default viewing settings used is the traditional static cropping which is deemed obsolete as it does not ensure the inclusion of the main subject of a visual content, resulting in an unsatisfactory user experience. This type of cropping usually follows center cropping which may dismiss the significant features within a visual frame.

The disclosure may provide an intelligent media reframing system capable of retaining significant features of visual media while displayed outside of a device's standard aspect ratio. Computer vision and image processing may be utilized for the establishment of an optimal cropping window based on determined areas of high significance and overlay considerations. As variable resolution displays are applicable for other technologies, such as virtual and augmented reality, device-to-device streaming, and atypical screens, some embodiments of the disclosure also may provide an innovative software to complement visual real estate implementations on hardware and justify the cost of their adoption.

According to an embodiment of the disclosure, the system and method may comprise merging or collation of the visual interests. The system and method may be used for variable resolution display devices. The system and method may comprise an overlay handling and inclusion method.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system that is used for context-aware visual media reframing for variable resolution displays.

Additional aspects will be set forth in part in the description which follows and, in part, will be apparent from the description, or may be learned by practice of the presented embodiments.

In accordance with an aspect of the disclosure, a method for processing visual media is provided. The method includes obtaining one or more frames from at least one input visual media, for at least one frame of the one or more frames, detecting one or more features from the at least one frame based on detection model, determining at least one cropping window based on the one or more detected features and information regarding an aspect ratio of display, obtaining one or more cropped frames based on the at least one cropping window, selecting one or more overlays based on one or more cropped out features, text, picture-in-picture display, and spaces left in the display, and generating one or more reframed frames by situating one or more selected overlays on the one or more cropped frame.

In accordance with another aspect of the disclosure, an apparatus for processing an image is provided. The apparatus includes at least one memory, including one or more storage media, storing instructions, and at least one processor communicatively coupled to the memory, wherein the instructions, when executed by the at least one processor individually or collectively, cause the apparatus to obtain one or more frames from at least one input visual media, for at least one frame of the one or more frames, detect one or more features from the at least one frame based on detection model, determine at least one cropping window based on the one or more detected features and information regarding an aspect ratio of a display, obtain one or more cropped frames based on the at least one cropping window, selecting one or more overlays based on one or more cropped out features, text, picture-in-picture display, and spaces left in the display, and generate one or more reframed frames by situating one or more selected overlays on the one or more cropped frame.

In accordance with another aspect of the disclosure, one or more non-transitory computer-readable storage media storing one or more computer programs including computer-executable instructions that, when executed by at least one processor of an apparatus individually or collectively, cause the apparatus to perform operations are provided. The operations include obtaining one or more frames from at least one input visual media, for at least one frame of the one or more frames, detecting one or more features from the at least one frame based on detection model, determining at least one cropping window based on the one or more detected features and information regarding an aspect ratio of a display, obtaining one or more cropped frames based on the at least one cropping window, selecting one or more overlays based on one or more cropped out features, text, picture-in-picture display, and spaces left in the display, and generating one or more reframed frames by situating one or more selected overlays on the one or more cropped frame.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a system for context-aware visual media reframing for variable resolution displays according to an embodiment of the disclosure;

FIG. 2 illustrates a flowchart for a method processing visual media for context-aware visual media reframing for variable resolution displays according to an embodiment of the disclosure;

FIG. 3 illustrates a flowchart for saliency-aware automatic video reframing (SA2VR) according to an embodiment of the disclosure;

FIG. 4A illustrates a flowchart for saliency-aware automatic video reframing (SA2VR) according to an embodiment of the disclosure;

FIG. 4B illustrates a method of signal fusion according to an embodiment of the disclosure;

FIG. 5A illustrates a flowchart for an optimal reframing strategy based on a motion energy of a general bounding box according to an embodiment of the disclosure;

FIG. 5B illustrates a method obtaining motion energy information according to an embodiment of the disclosure;

FIG. 5C illustrates a build graph according to an embodiment of the disclosure;

FIG. 6 illustrates a video post-processing according to an embodiment of the disclosure;

FIG. 7 illustrates a reframed visual content according to an embodiment of the disclosure;

FIG. 8 illustrates a method providing optimal video cropping for floating windows in virtual and augmented reality according to an embodiment of the disclosure;

FIG. 9 illustrates a method providing content aware video aspect ratio adaptation for device-to-device streaming according to an embodiment of the disclosure;

FIG. 10 illustrates a method providing a smart aspect ratio adaptation for atypical screens according to an embodiment of the disclosure;

FIG. 11 illustrates a method providing auto-reframed videos during streaming according to an embodiment of the disclosure;

FIG. 12 illustrates a cropping method according to an embodiment of the disclosure; and

FIG. 13 illustrates a flowchart illustrating a method processing visual media according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

The disclosure includes the generation of an optimal cropping window from collated boundary boxes containing the detected significant features of the input visual media using computer vision and image processing. According to an embodiment of the disclosure, the inclusion of a plurality of significant elements within a visual frame and provision of a dynamic cropping system for variable resolution displays can be provided.

The disclosure relates to a system and method processing visual media. The system may be used for context-aware visual media reframing for variable resolution displays.

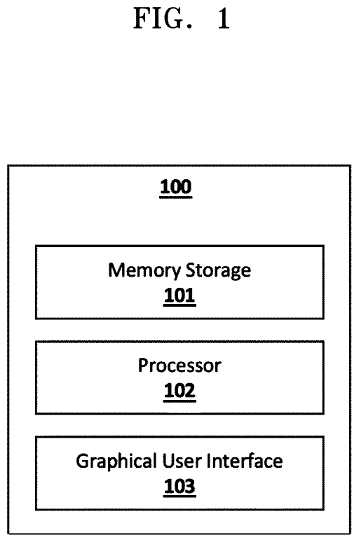

FIG. 1 illustrates a system for context-aware visual media reframing for variable resolution displays according to an embodiment of the disclosure.

Referring to FIG. 1, a system 100 comprises of at least one memory storage 101, at least one processor 102, and at least one graphical user interface (GUI) 103 in communication with each other. According to an embodiment of the disclosure, the system 100 may exclude at least one of these components or may add at least one other component. For example, the system may exclude graphical user interface 103.

The system 100 accepts an at least one input visual medium, wherein the input can be stored in the memory storage 101. The processor 102 performs one or more computer vision and image processing techniques for intelligent reframing of the input visual medium. The reframed output may be then displayed in the graphical user interface 103.

According to the embodiments of the disclosure, the memory storage device 101 can be any medium or mechanism for storing or transmitting information in a form readable by a machine or computer. The memory storage device 101 can have a primary memory device and/or a secondary memory device as a backup storage device. The memory device can be read only memory (ROM), random access memory (RAM), magnetic disk storage media, hard disk storage, optical storage media, flash memory devices, universal serial bus (USB) drive, secure digital (SD) card, memory chip, or a combination thereof. The memory storage device 101 can be linked to the processor 102. The processor 102 can be any microcontroller, microprocessor, central processing unit (CPU), graphics processing unit (GPU), tensor processing unit (TPU), field programmable gate arrays (FPGA), or any hardware device capable of processing data, issuing instructions, or executing calculations. For example, the processing unit can use advanced processing means, such as intelligent systems, at least one predictive algorithm, at least one artificial neural networks, fuzzy logic, at least one genetic algorithm, machine learning, deep learning, image processing, computer vision, or combinations thereof.

The system and method can be used for context-aware visual media reframing for variable resolution displays using computer vision and image processing, comprising the general steps of receiving through a variable resolution display device a visual media input, preparing the input using image processing techniques, detecting significant features within the visual frame using computer vision methods, generating an optimal cropping window based on the detected significant features, cropping the visual input using the optimal cropping window, and post-processing the cropped visual with overlay handling and inclusion.

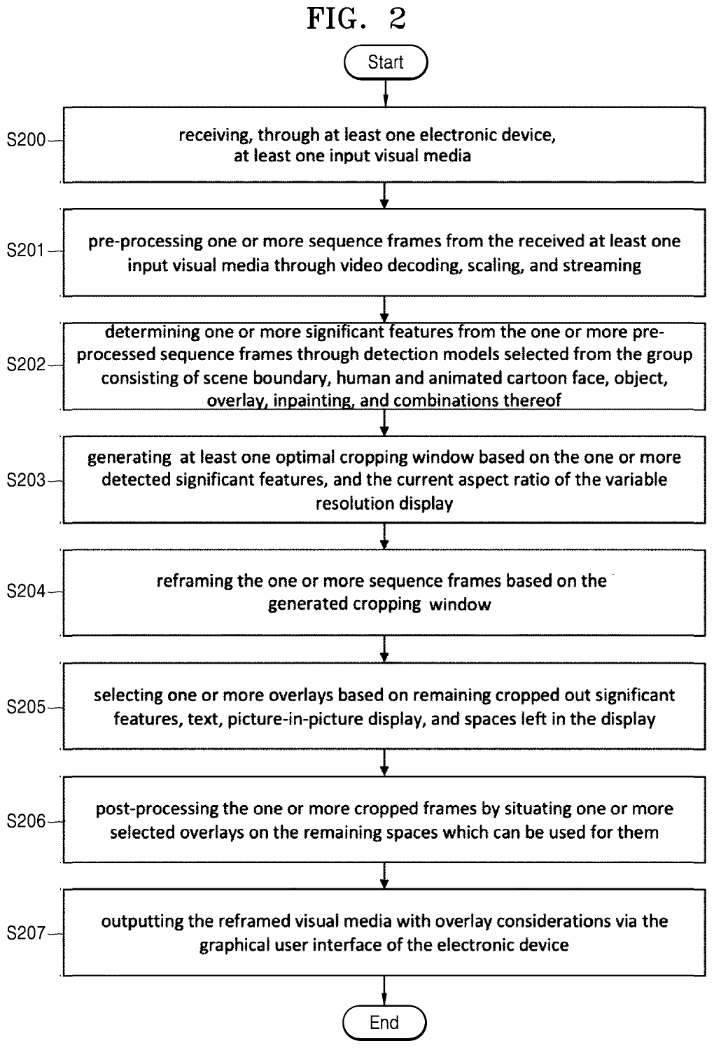

FIG. 2 illustrates a flowchart for a method of processing visual media for context-aware visual media reframing for variable resolution displays, according to an embodiment of the disclosure.

Referring to FIG. 2, the method comprises the operations of:
receiving, through at least one electronic device, at least one input visual media in operation S200;
pre-processing one or more sequence frames from the input of operation S200 through video decoding, scaling, and streaming in operation S201;
determining one or more significant features from the output of operation S201 through detection models selected from the group consisting of scene boundary, human and animated cartoon face, object, overlay, inpainting, and combinations thereof in operation S202;
generating at least one optimal cropping window based on the output of operation S202, and the current aspect ratio of the variable resolution display in operation S203;
reframing the one or more sequence frames based on the optimal cropping window generated from operation S203 in operation S204;
selecting one or more overlays based on at least one of the remaining cropped out significant features, text, picture-in-picture display, and spaces left in the display in operation S205;
post-processing the one or more cropped frames from operation S204 by situating one or more selected overlays from operation S205 on the remaining spaces which can be used for them in operation S206; and
outputting the reframed visual media from operation S206 via the graphical user interface 103 of the electronic device or other electronic devices in operation S207.

According to an embodiment of the disclosure, at least one of operations may be performed by other device, skipped or at least one operation may be added.

The cropping window operation S203 will be generated from a collated set of boundary boxes obtained from operation S202 with varying thresholds of vicinity and significance in terms of size and quantity.

In an embodiment of the disclosure, the center cropping of image, and retention of previous cropping windows will be implemented to generate the optimal cropping window if no significant features are detected.

In an embodiment of the disclosure, the boundary boxes will be collated through signal fusion based on their respective motion energy.

In an embodiment of the disclosure, the electronic device can be any device having variable resolution displays, such as, but not limited to, foldable and rollable devices, virtual reality and augmented reality devices, and atypical screen devices.

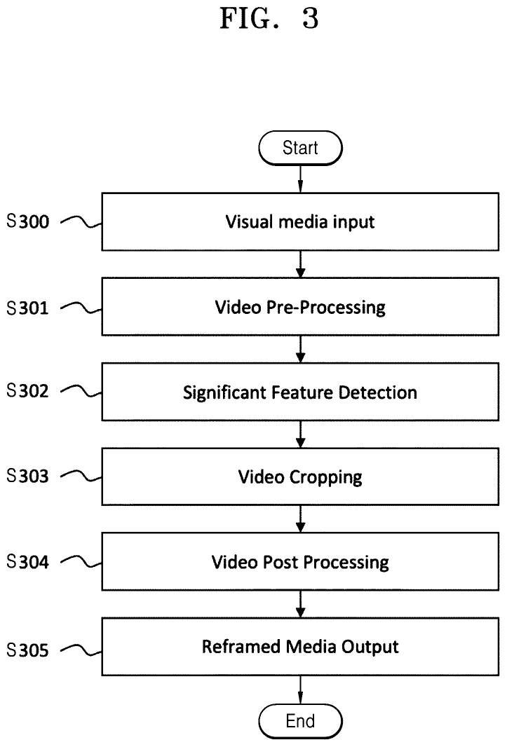

FIG. 3 illustrates a flowchart for saliency-aware automatic video reframing (SA2VR) according to an embodiment of the disclosure.

Referring to FIG. 3, in operation S300, the electronic device receives a visual media input in the form of pictures, videos, infographics, diagrams, charts, websites, social media pages, or combinations thereof. In operation S301, the visual media input undergoes video pre-processing using image processing techniques. In operation S302, one or more points of high visual interest are located within the prepared frames from the previous operation using significant feature detection. In operation S303, based on these detected significant features, an optimal cropping window is generated to facilitate the video cropping process. In operation S304, the video post-processing including at least one of overlay handling and inclusion is carried out. In operation S305, the system produces a reframed visual media output packaging the cropping and overlay processes. According to an embodiment of the disclosure, at least one of operations may be performed by other device, skipped or at least one operation may be added.

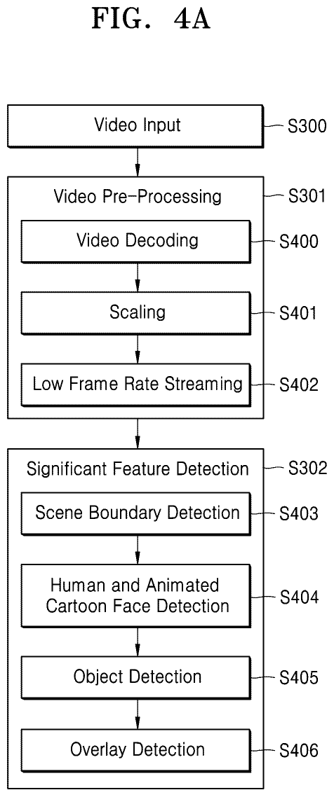

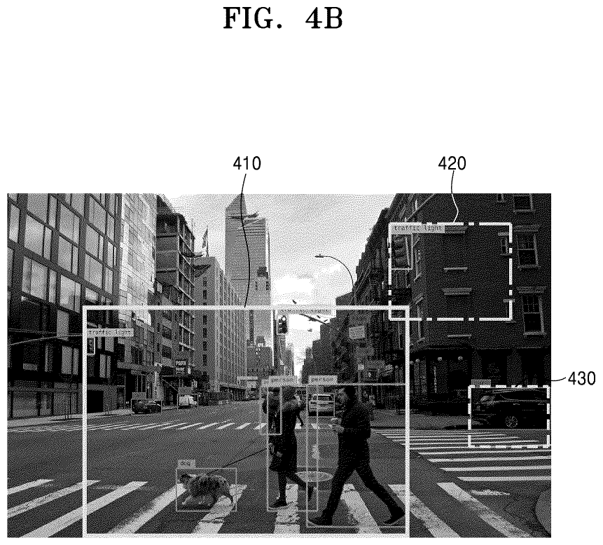

FIG. 4A illustrates a flowchart for saliency-aware automatic video reframing (SA2VR) according to an embodiment of the disclosure.

Referring to FIG. 4A, the video pre-processing in operation S301 further comprises the operations of video decoding S400, scaling S401, and low frame rate streaming S402. The significant feature detection in operation S302 is executed using detection operations, such as, but not limited to, scene boundary detection in operation S403, human and animated cartoon face detection in operation S404, object detection in operation S405, and overlay detection in operation S406. In operation S407, to guide the video cropping process, signal fusion is performed, wherein the retrieved weighted detections are collated for an optimal cropping window. In operation S408, to package and retrieve the outputs of each stage for the final reframed output, data encoding is conducted.

In operation S403, whether there is a change of scenes detected may be determined based on at least one of content change or color change. For example, scene boundary detection may comprise identifying whether an average value associated with R, G, B values in a frame crosses a first threshold associated with R, G, B values. Scene boundary detection may comprise identifying whether difference between two frames crosses a second threshold. However, any suitable scene boundary detection operation may be used to detect whether there is a change of scene. If change of scene is detected, a frame used for cropping may be changed. The previous frame may not be utilized as reference for cropping and may default as the initial trajectory.

In operation S404, human and animated cartoon face detection may comprise any suitable architecture to detect face including BlazeFace, or single shot multibox detector (SSD). In operation S405, object detection may comprise any suitable architecture to detect object including EfficientDet, or bi-directional feature network (BiFPN). In some embodiments of the disclosure, at least one of operations may be performed by at least one other device, skipped or at least one operation may be added.

In an embodiment of the disclosure, the saliency-aware automatic video reframing (SA2VR) technology may work both on-cloud and on-device, with the latter being possible given the models used for detection are lightweight or are within the capabilities of the device.

FIG. 4B illustrates a method of signal fusion according to an embodiment of the disclosure.

Referring to FIG. 4B, signal fusion may include at least one of collation of detected one or more bounding boxes, or determination of box with large significance. Signal fusion may contribute to remove redundancy, consider significance of bounding boxes and propose a set of bounding boxes which maximizes amount of object within bounding box while maintaining required aspect ratio.

Bounding box may comprise an area of interest including one or more significant features and the significant feature may correspond to one or more objects in visual media. According to some embodiments of this disclosure, any suitable size or sizes and shape or shapes of bounding box may be used.

One or more bounding boxes are obtained based on at least one of scene boundary detection in operation S403, human and animated cartoon face detection in operation S404, object detection in operation S405, and overlay detection in operation S406. A set of collated bounding boxes may be obtained based on at least one of screen size resolution or vicinity of one or more bounding boxes. Collated bounding box may comprise individual bounding box corresponding to a feature and merged bounding box including two or more individual bounding boxes.

General bounding box may be determined based significance information corresponding to at least one bounding box including collated bounding boxes. For example, a bounding with the largest significance may be determined to be general bounding box. If there is no bounding box, general box may be determined to center of an image or a frame.

Significance may be weighted based on at least one of size of significant feature, size of significant features, quantity of significant features or type of significant features within the bounding box. Significance may be weighted based on categorical information, such as prioritizing face, stationary objects or non-stationary objects.

For example, referring to FIG. 4B, significance value of each bounding box may be determined based on a number of significant features as shown below in Table 1. If bounding box 410 include 15 significant features, significance of bounding box may be 15. If bounding box 420 or bounding box 430 includes 1 significant feature, significance of bounding box may be 1. Bounding box 410 is determined to be general bounding box.

TABLE 1

| Bounding Box | Significance |
|---|---|
| Bounding Box 410 | 15 |
| Bounding Box 420 | 1 |
| Bounding Box 430 | 1 |

Significance value of each bounding box may be weighted based on type information as shown below in Tables 2 and 3. However, weight is not limited as Table 2, any suitable value or type can be configured based on application.

TABLE 2

| Type | Weights |
|---|---|
| Person | 0.9 |
| Car | 0.6 |
| Dog | 0.6 |
| Traffic light | 0.3 |
| Sign | 0.2 |

If bounding box 410 include 15 significant features and is weighted, significance of bounding box may be 8. If bounding box 420 include 15 significant features, significance of bounding box may be 8. Bounding box 410 is determined to be general bounding box.

TABLE 3

| Bounding Box | Significance |
|---|---|
| Bounding Box 410 | 8 |
| Bounding Box 420 | 0.3 |
| Bounding Box 430 | 0.6 |

If a is an array of one or more bounding boxes corresponding one or more detected objects, opt_box is an array of one or more bounding boxes or collated bounding boxes used for optimization, general bounding may be determined based on Algorithm 1. All bounding boxes may be initialized to fit with respect to the maximum possible cropping windows or the maximum screen size with respect to each given aspect ratio. We assume that bounding boxes are numbered 0 to N-1 where N is the number of bounding boxes.

Algorithm 1

```
opt_box[0] = a[0],
Initialize opt_box[1] to opt_box[N−1] to dummy boxes with significance
of −1.
merge(b1, b2) is a function that merges two boxes if possible
otherwise it returns a dummy box with significance, − 1
for i from 1 to N−1:
  for j from 0 to i−1:
    opt_box[i] = Bounding box with higher significance value among
      merge(opt_box[j], a[i]), a[i], and opt_box[i]
get box with maximum significance from opt_box
```

According to an embodiment of this disclosure, obtaining merged bounding box based on a plurality of bounding boxes may comprise fitting the plurality of bounding boxes within the proposed region of the merged bounding box based on required aspect ratio.

For example, coordinate of bounding box may be represented as (x, y, w, h), where x, y are the upper leftmost point of the bounding box, w, h are the width and the height of the bounding box, respectively. Two bounding boxes (b1, b2) are represented as (x_{b1}, y_{b1}, w_{b1}, h_{b1}), (x_{b2}, y_{b2}, w_{b2}, h_{b2}).

If xₘᵢₙ, yₘᵢₙ refers to the upper left coordinates of the merged bounding box, upper-left coordinate may be determined based on Equation 1.

$$\begin{matrix}{x}_{min} = \{ \begin{matrix}{x}_{b 1} , & {x}_{b 1} < {x}_{b 2} \\ {x}_{b 1} , & {x}_{b 1} \geq {x}_{b 2}\end{matrix} \\ {y}_{min} = \{ \begin{matrix}{y}_{b 1} , & {y}_{b 1} < {y}_{b 2} \\ {y}_{b 1} , & {y}_{b 1} \geq {y}_{b 2}\end{matrix}\end{matrix} \qquad Equation 1$$

The system may determine if distance between one or more boxes to be collated fits within the width and height requirements based on Equations 2 and 3.

$$\begin{matrix}{x}_{b} = {x}_{min} , {y}_{b} = {y}_{min} , \\ {w}_{b} = \{ \begin{matrix}{x}_{b 1} + {w}_{b 1} - {x}_{min} , & {x}_{b 1} + {w}_{b 1} > {x}_{b 2} + {w}_{b 2} \\ {x}_{b 2} + {w}_{b 2} - {x}_{min} , & {x}_{b 1} + {w}_{b 1} \leq {x}_{b 2} + {w}_{b 2}\end{matrix} \\ {h}_{b} = \{ \begin{matrix}{y}_{b 1} + {h}_{b 1} - {y}_{min} , & {x}_{b 1} + {h}_{b 1} > {y}_{b 2} + {h}_{b 2} \\ {y}_{b 2} + {h}_{b 2} - {y}_{min} , & {x}_{b 1} + {h}_{b 1} \leq {y}_{b 2} + {h}_{b 2}\end{matrix}\end{matrix} \qquad Equation 2$$

xₘᵢₙ, yₘᵢₙ are reassigned as x_{b} and y_{b}, which are upper left coordinates of the merged bounding box. w_{b1} and w_{b2} are the widths of bounding box b1 and bounding box b2. h_{b1} and h_{b2} are heights of bounding box b1 and bounding box b2.

$$\begin{matrix}\{ \begin{matrix}{x}_{min} + {x}_{t} \geq {x}_{b 1} + {w}_{b 1} \\ {x}_{min} + {x}_{t} \geq {x}_{b 2} + {w}_{b 2}\end{matrix} \\ \{ \begin{matrix}{y}_{min} + {y}_{t} \geq {y}_{b 1} + {h}_{b 1} \\ {y}_{min} + {y}_{t} \geq {y}_{b 2} + {h}_{b 2}\end{matrix}\end{matrix} \qquad Equation 3$$

The two bounding boxes may be considered for merging if Equation 3 is satisfied, in that the area comprising both bounding box b1 and b2 may fit in maximum size of a merged bounding box. Values of and xₜ and yₜ may be set based on at least one of screen size and aspect ratio. For example, xₜ, yₜ are maximum allowed width and height per collated bounding box where xₜ, yₜ follow required aspect ratio. The system may also utilize another coordinate for the origin reference of the bounding boxes, such as bottom-left, center, or the like.

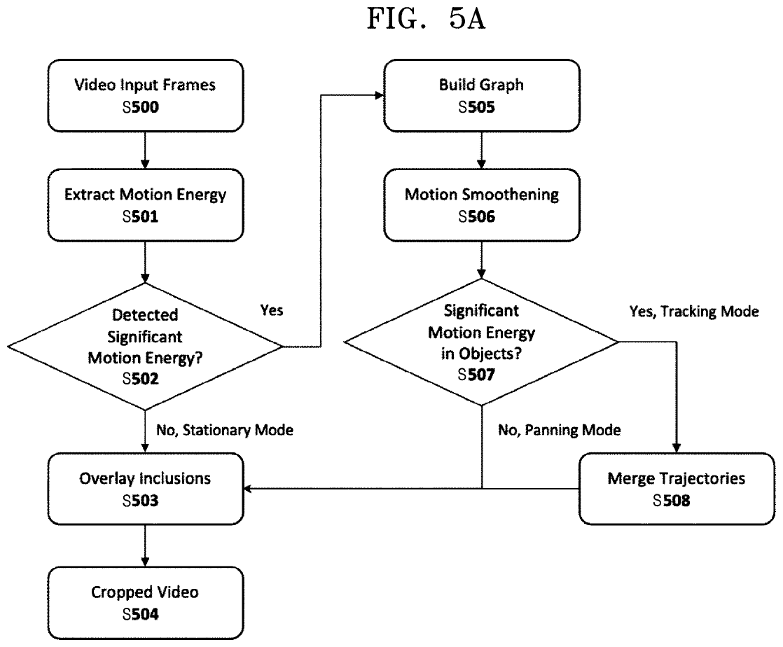

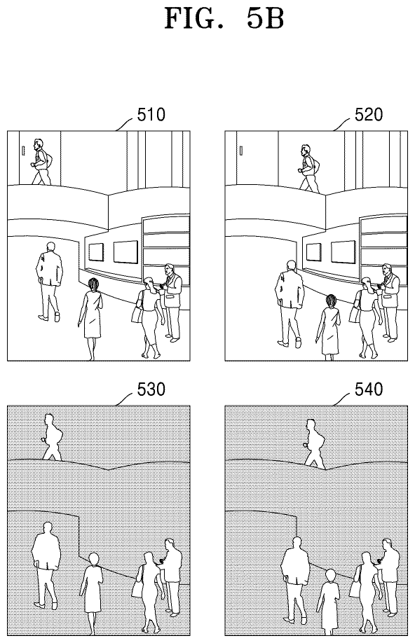

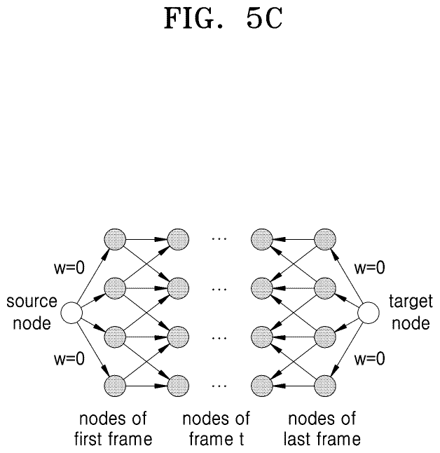

FIG. 5A illustrates a flowchart for an optimal reframing strategy based on a motion energy of a general bounding box according to an embodiment of the disclosure.

Referring to FIG. 5A, in operations S500-S501, for the signal fusion in operation S407, the video input frames undergo the extraction of their respective motion energy. In operations S502, the system then determines if there is a detected motion energy within the frames. In the event that there is an absence of a significant motion energy, the system operates in stationary mode and directly performs overlay inclusion in operation S503 and video cropping in operation S504.

On the other hand, the presence of a significant motion energy drives the system to build a graph in operation S505 of the motion energies and carry out motion smoothening in operation S506. The output of the previous process then undergoes another batch of significant motion energy detection for the objects in operation S507. With the absence of a significant motion energy, the system is forced to enter the panning mode, which immediately facilitates the overlay inclusion in operation S503 and video cropping in operation S504. Whereas the presence of a significant motion energy allows for tracking mode, which merges trajectories in operation S508 before finally performing the overlay inclusion in operation S503 and video cropping in operation S504 process.

According to the embodiments of this disclosure, the criteria to consider a motion energy as significant depends on three modes-stationary, panning, and tracking. The stationary mode is considered if minimal or no motion energy is detected in the general bounding box or object bounding box. The panning mode is considered if a significant motion energy is detected in the general bounding box. Whereas the tracking mode is considered if a significant motion energy is detected in each object bounding boxes.

FIG. 5B illustrates a method obtaining motion energy information, according to an embodiment of the disclosure.

Referring to FIG. 5B, motion energy may be obtained based on differences between at least two frames, which can include but not limited to color space differences, optical flow, and pixel changes. Obtaining motion energy may comprise comparing between two frames including changes of area and coordinates of each possible bounding box including collated bounding box and individual bounding box.

Color space may be obtained at least one of RGB (Red, Green, Blue), HSV (Hue, Saturation, and Value), or other color-based parameters. Motion energy may be determined based on difference between one or more bounding boxes of a first frame 510 and one or more bounding boxes of a second frame 520. For example, motion energy may be determined based on average differences between color space 530 of previous frame (i.e., the first frame 510) and color space 540 of current frame (i.e., second frame 520).

FIG. 5C illustrates a build graph according to an embodiment of the disclosure.

Referring to FIG. 5C, a build graph may comprise at least one of one or more nodes, one or more layers, one or more edges. Layer may correspond to frame, node may correspond to bounding box, edge may correspond to motion energy.

For example, if motion energy of general bounding box is significantly bigger than motion energy of any other bounding box or panning mode is required, one node may correspond to general bounding box and edge may correspond to motion energy. If motion energy of other bounding boxes is bigger than motion energy of general bounding box or tracking mode is required, one or more nodes correspond to one or more bounding boxes and edges may correspond to motion energy, the system may merge or select the best trajectories based on collated bounding box traversal.

The build graph may be traversed through maximizing total motion energy of cropped frames, limiting potential jittery-ness of cropped window. To obtain optimal trajectory path on tracking mode, the system may merge all trajectories of each cropping window through maximizing a collated bounding box traversal. This process may be mitigated for panning mode using general bounding box.

Based on build graph, optimal cropping window may be determined. For example, if significant motion energy of general bounding box between previous frame and current frame is not detected or stationary mode is required, optimal cropping window may not change or may maintain.

If significant motion energy of general bounding box between previous frame and current frame is detected, the system may identify if current frame is a new scene or still part of the scene based on scene boundary detection. If a new scene is detected, new build graph may be generated and optimal cropping window may be determined based on the new build graph.

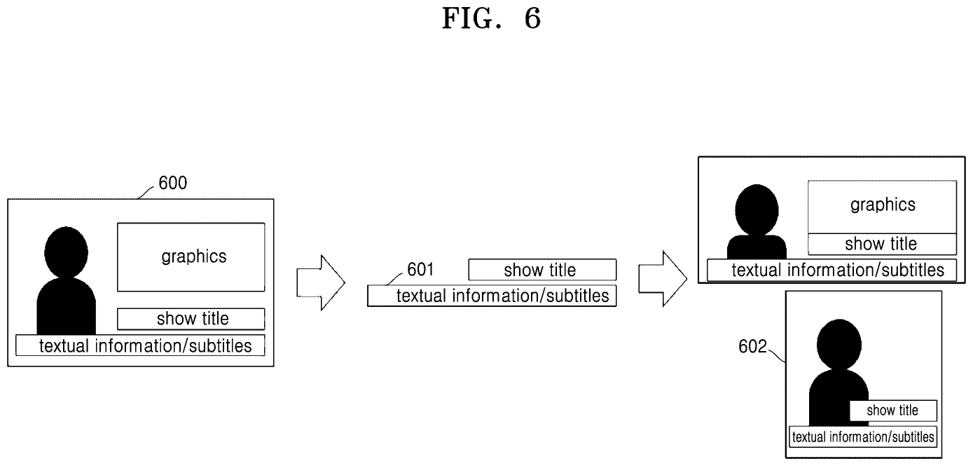

FIG. 6 illustrates a video post-processing according to an embodiment of the disclosure.

Referring to FIG. 6, for example, text overlays 601 are extracted from the source image 600 and added to the cropped frames 602. According to an embodiment of the disclosure, one or more objects may be extracted from the source image 600 and added to the cropped frames 602

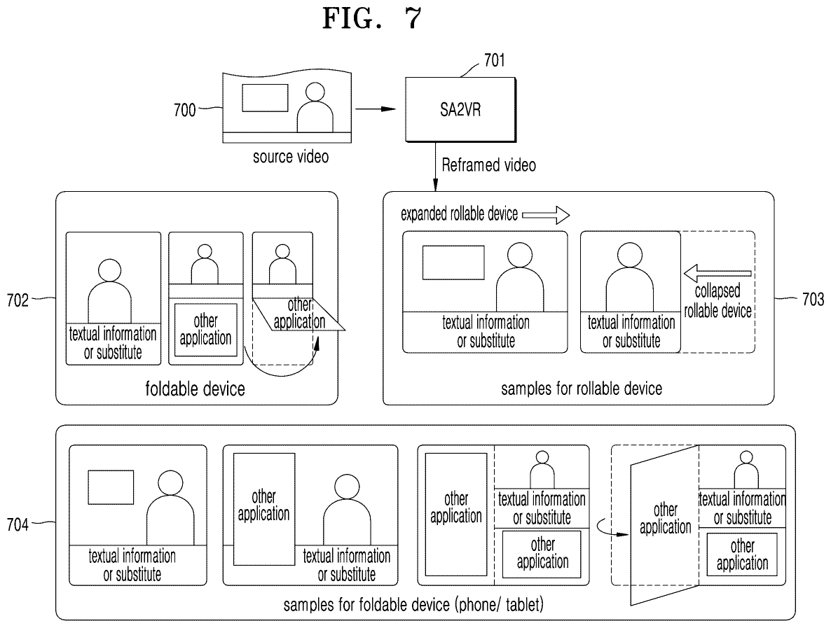

FIG. 7 illustrates a reframed visual content according to an embodiment of the disclosure.

Referring to FIG. 7, a source video 700 may undergo reframing using SA2VR 701 for a foldable phone 702, rollable device 703, and foldable phone or tablet of larger aspect ratio 704. The variable resolution display in 702 shows a reframed visual content based on the vertical dimension of the device when extended, and another output in an aspect ratio matching half of the device as it is folded or used in a split screen setting-all while retaining the significant figure in the frame, as well as the textual information or subtitles.

Whereas in 703, the reframed visual content is based on the horizontal axis for the expanded device showing the entirety of the source video. Another reframed version of the visual content, which follows the vertical axis as the device is collapsed, further demonstrates the removal of the least significant objects within the frame and retention of the most significant features for a more desirable viewing experience. As for the larger aspect ratio 704, the expanded device shows the entirety of the source video at the first instance, a reframed version following the vertical axis in a lengthwise split screen, and another reframed visual following half of one side of the split screen for windows exceeding two splits.

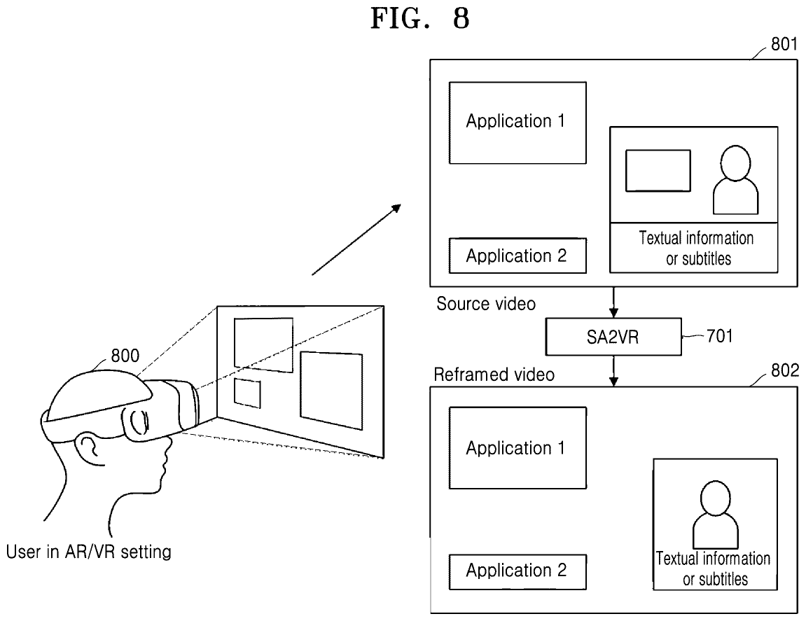

FIG. 8 illustrates a method providing optimal video cropping for floating windows in virtual and augmented reality according to an embodiment of the disclosure.

Referring to FIG. 8, a user 800 demonstrates viewing multiple floating windows within a frame shown in the two dimensional (2D) plane. From the source video 801, SA2VR 701 is performed on one or more floating windows to adjust their respective aspect ratios such that all user interface elements fit within the frame. The reframed video 802 may show only at least one of the significant objects within windows being retained as a result of the SA2VR 701 process.

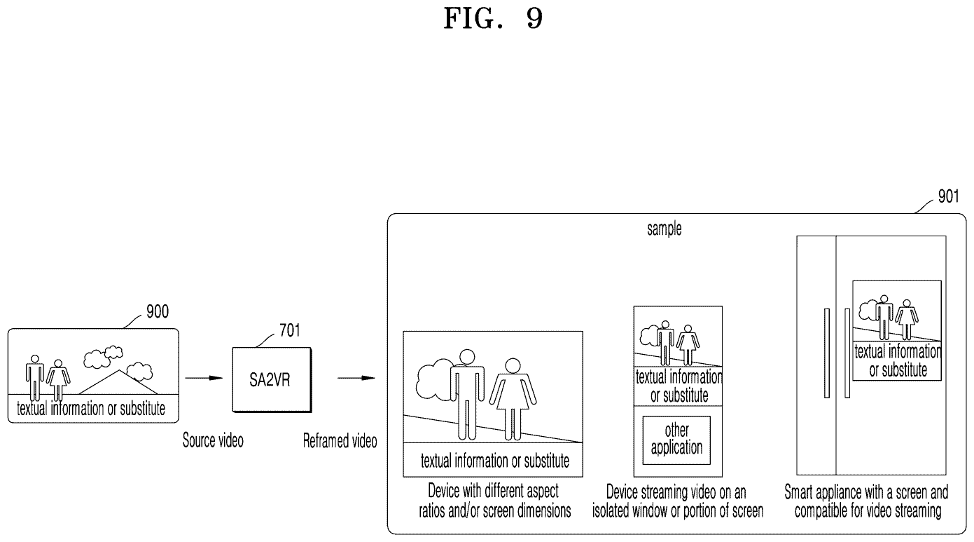

FIG. 9 illustrates a method providing content aware video aspect ratio adaptation for device-to-device streaming according to an embodiment of the disclosure.

Referring to FIG. 9, this method demonstrates the reframing of the source device's video 900 according to a destination device's aspect ratio 901 such that the video is cropped to fit the resolution of the destination device while considering the significant features and overlays. In 901, use cases for devices with different aspect ratios and/or screen dimensions, devices streaming the source video on an isolated window or portion of the screen, and smart appliances with a screen compatible for video streaming are demonstrated.

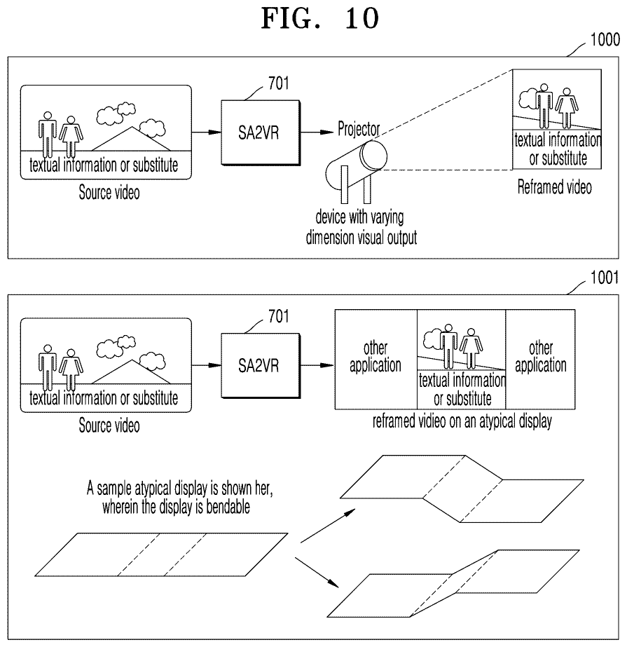

FIG. 10 a method providing a smart aspect ratio adaptation for atypical screens according to an embodiment of the disclosure.

Referring to FIG. 10, in sample scenario 1000, the source video is processed using SA2VR 701 to achieve the optimal aspect ratio to be projected by a device with varying dimension visual output. As illustrated, only the detected significant figures were retained, alongside the textual information or subtitles. Another embodiment 1001, demonstrates the sample reframed output for bendable screens having unequal partitions.

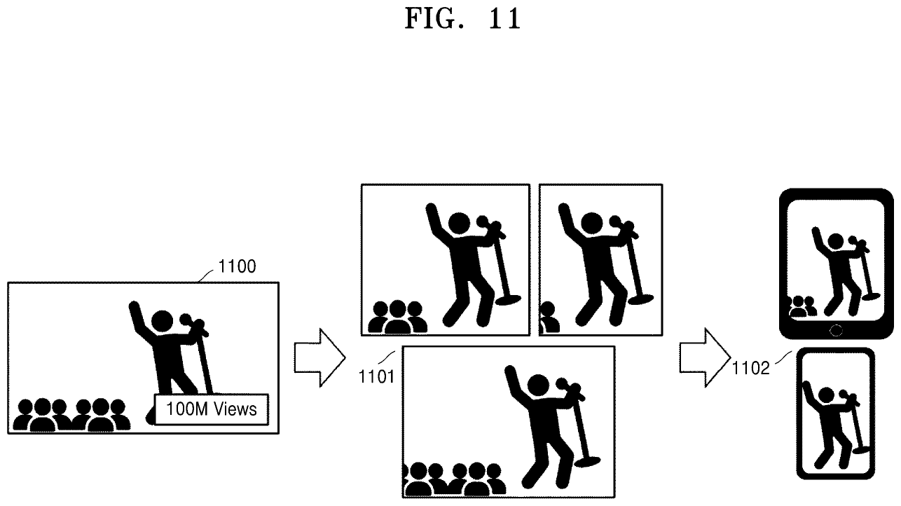

FIG. 11 illustrates method providing auto-reframed videos during streaming according to an embodiment of the disclosure.

Referring to FIG. 11, the present system and method can be implemented in certain videos in a streaming platform popular to users with the processing being server-based. The source video 1100 can be cropped multiple times as seen in 1101 with the aspect ratio being based on the end devices wherein the video is most popular in. This allows for faster processing and optimal reframing fitting most end devices 1102.

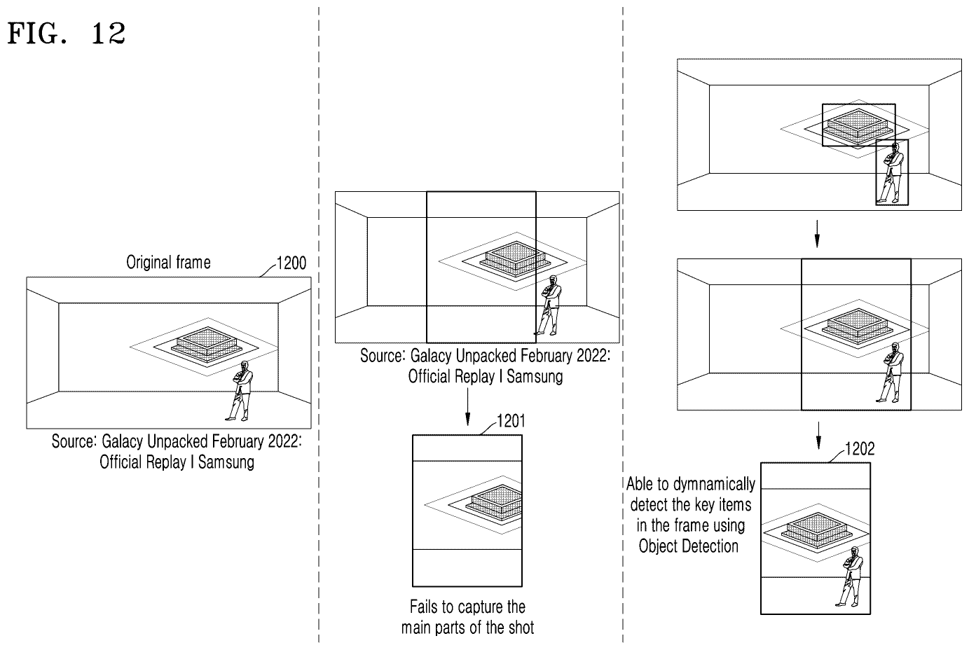

FIG. 12 illustrates a cropping method according to an embodiment of the disclosure.

Referring to FIG. 12, an original frame 1200 reframed using the usual centered cropping method 1201 may show a portion of one significant feature and fail to include all the main parts of the shot. According to an embodiment of the disclosure, the collation of the boundary boxes detecting multiple significant features may result in an cropping area 1202 for the targeted dimension.

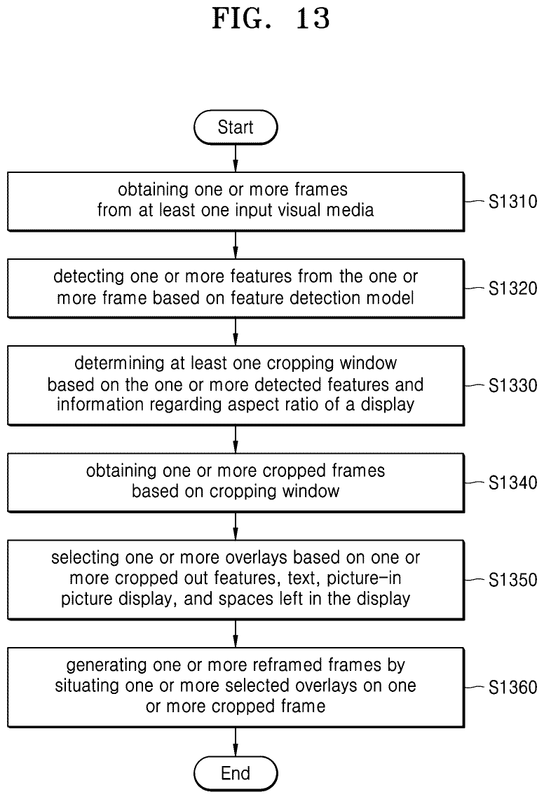

FIG. 13 illustrates a flowchart illustrating a method processing visual media according to an embodiment of the disclosure.

Referring to FIG. 13, a method 1300 may be performed by system 100 of FIG. 1.

Referring to FIG. 11, in operation S1310, the method may include obtaining one or more frames from at least one input visual media.

In operation S1320, the method 1300 may include, for at least one frame of the one or more frames, detecting one or more features from the at least one frame based on detection model. The detection model may comprise at least one of a scene boundary detection, a human and animated cartoon face detection, an object detection, or an overlay detection

In operation S1330, the method 1300 may include determining at least one cropping window based on the one or more detected features and information regarding aspect ratio of display. The cropping window may be determined based on significance related to a collated set of at least one object area. The cropping window may be smaller than or equal to a size determined based on at least one of the aspect ratio or the size of the display. The at least one object area may correspond to the detected one or more features. Significance of an object area may be determined based on at least one of feature size, feature quantity, and feature type in the object area. If a plurality of features are detected, the collated set of at least one object area may include at least one merged object area obtained based on the at least one object area. The cropping window may be set to the center cropping of image, or retention of previous cropping windows if no features are detected.

In operation S1340, the method 1300 may include obtaining one or more cropped frames based on the cropping window.

In operation S1350, the method 1300 may include selecting one or more overlays based on one or more cropped out features, text, picture-in-picture display, and spaces left in the display.

In operation S1360, the method 1300 may include generating one or more reframed frames by situating one or more selected overlays on the one or more cropped frame. The method 1300 may include outputting the reframed visual media comprising the one or more reframed frames via the graphical user interface corresponding to the display. The one or more reframed frames may be generated either on-cloud or on-device. If a change of aspect ratio is detected, the method 1300 may include obtaining new one or more reframed frames based on the change.

In some embodiments of the disclosure, at least one of operations may be performed by other device, skipped or at least one operation may be added.

According to an aspect of the disclosure, a method for processing visual media is provided., comprising. The method may include obtaining one or more frames from at least one input visual media. The method may include, for at least one frame of the one or more frames, detecting one or more features from the at least one frame based on detection model. The method may include determining at least one cropping window based on the one or more detected features and information regarding aspect ratio of display. The method may include obtaining one or more cropped frames based on the cropping window; selecting one or more overlays based on one or more cropped out features, text, picture-in-picture display, and spaces left in the display. The method may include generating one or more reframed frames by situating one or more selected overlays on the one or more cropped frame.

According to an embodiment of the disclosure, the detection model may comprise at least one of a scene boundary detection, a human and animated cartoon face detection, an object detection, or an overlay detection.

According to an embodiment of the disclosure, the cropping window may be determined based on significance related to a collated set of at least one object area.

According to an embodiment of the disclosure, the cropping window may be smaller than or equal to a size determined based on at least one of the aspect ratio or the size of the display.

According to an embodiment of the disclosure, the at least one object area may correspond to the detected one or more features. According to an embodiment of the disclosure, significance of an object area may be determined based on at least one of feature size, feature quantity, and feature type in the object area.

According to an embodiment of the disclosure, if a plurality of features are detected, the collated set of at least one object area may include at least one merged object area obtained based on the at least one object area. According to an embodiment of the disclosure, the cropping window may be set to the center cropping of image, or retention of previous cropping windows if no features are detected.

According to an embodiment of the disclosure, the method may include outputting the reframed visual media comprising the one or more reframed frames via the graphical user interface corresponding to the display.

According to an embodiment of the disclosure, the one or more reframed frames may be generated either on-cloud or on-device.

According to an embodiment of the disclosure, if a change of aspect ratio is detected, the method may include obtaining new one or more reframed frames based on the change.

According to an aspect of the disclosure, an apparatus including at least one memory configured to store instructions, and at least one processor is provided. The at least one processor may be configured, when executing the instructions, to obtain one or more frames from at least one input visual media. The at least one processor may be configured, when executing the instructions, to detect one or more features from the at least one frame based on detection model for at least one frame of the one or more frames. The at least one processor may be configured, when executing the instructions, to determine at least one cropping window based on the one or more detected features and information regarding aspect ratio of display. The at least one processor may be configured, when executing the instructions, to obtain one or more cropped frames based on the cropping window; selecting one or more overlays based on one or more cropped out features, text, picture-in-picture display, and spaces left in the display. The at least one processor may be configured, when executing the instructions, to generate one or more reframed frames by situating one or more selected overlays on the one or more cropped frame.

According to an embodiment of the disclosure, the detection model may comprise at least one of a scene boundary detection, a human and animated cartoon face detection, an object detection, or an overlay detection.

According to an embodiment of the disclosure, the cropping window may be determined based on significance related to a collated set of at least one object area.

According to an embodiment of the disclosure, the cropping window may be smaller than or equal to a size determined based on at least one of the aspect ratio or the size of the display.

According to an embodiment of the disclosure, the at least one object area may correspond to the detected one or more features.

According to an embodiment of the disclosure, significance of an object area may be determined based on at least one of feature size, feature quantity, and feature type in the object area.

According to an embodiment of the disclosure, if a plurality of features are detected, the collated set of at least one object area may include at least one merged object area obtained based on the at least one object area.

According to an embodiment of the disclosure, the cropping window may be set to the center cropping of image, or retention of previous cropping windows if no features are detected.

According to an embodiment of the disclosure, the at least one processor may be configured to output the reframed visual media comprising the one or more reframed frames via the graphical user interface corresponding to the display.

According to an embodiment of the disclosure, the one or more reframed frames may be generated either on-cloud or on-device.

According to an embodiment of the disclosure, if a change of aspect ratio is detected, the at least one processor may be configured to obtain new one or more reframed frames based on the change.

According to an aspect of the disclosure, a computer-readable medium containing instructions that, when executed, cause at least one processor of an electronic device is provided. The computer-readable medium may cause at least one processor of an electronic device to obtain one or more frames from at least one input visual media. The computer-readable medium may cause at least one processor of an electronic device to detect one or more features from the at least one frame based on detection model for at least one frame of the one or more frames. The computer-readable medium may cause at least one processor of an electronic device to determine at least one cropping window based on the one or more detected features and information regarding aspect ratio of display. The computer-readable medium may cause at least one processor of an electronic device to obtain one or more cropped frames based on the cropping window; selecting one or more overlays based on one or more cropped out features, text, picture-in-picture display, and spaces left in the display. The computer-readable medium may cause at least one processor of an electronic device to generate one or more reframed frames by situating one or more selected overlays on the one or more cropped frame.

According to an embodiment of the disclosure, the detection model may comprise at least one of a scene boundary detection, a human and animated cartoon face detection, an object detection, or an overlay detection.

According to an embodiment of the disclosure, the cropping window may be determined based on significance related to a collated set of at least one object area.

According to an embodiment of the disclosure, the cropping window may be smaller than or equal to a size determined based on at least one of the aspect ratio or the size of the display.

According to an embodiment of the disclosure, the at least one object area may correspond to the detected one or more features.

According to an embodiment of the disclosure, significance of an object area may be determined based on at least one of feature size, feature quantity, and feature type in the object area.

According to an embodiment of the disclosure, if a plurality of features are detected, the collated set of at least one object area may include at least one merged object area obtained based on the at least one object area.

According to an embodiment of the disclosure, the cropping window may be set to the center cropping of image, or retention of previous cropping windows if no features are detected.

According to an embodiment of the disclosure, the computer-readable medium may cause at least one processor of an electronic device to output the reframed visual media comprising the one or more reframed frames via the graphical user interface corresponding to the display.

According to an embodiment of the disclosure, the one or more reframed frames may be generated either on-cloud or on-device.

According to an embodiment of the disclosure, if a change of aspect ratio is detected, the computer-readable medium may cause at least one processor of an electronic device to obtain new one or more reframed frames based on the change.

It is contemplated for embodiments described herein to extend to individual elements and concepts described herein, independently of other concepts, ideas or system, as well as for embodiments to include combinations of elements recited anywhere in this application. Moreover, it is contemplated that a feature described either individually or as part of an embodiment may be combined with other individually described features, or parts of other embodiments of the disclosure, even if the other features and embodiments make no mention of the feature. Hence, the absence of describing combinations should not preclude the inventor from claiming rights to such combinations.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method, performed by an apparatus, for processing an image, the method comprising:
obtaining one or more frames from at least one input visual media;
for at least one frame of the one or more frames, detecting one or more features from the at least one frame based on feature detection model;
determining at least one cropping window based on the one or more detected features and information regarding an aspect ratio of a display;
obtaining one or more cropped frames based on the cropping window;
selecting one or more overlays based on one or more cropped out features, text, picture-in-picture display, and spaces left in the display; and
generating one or more reframed frames by situating one or more selected overlays on the one or more cropped frame.

2. The method of claim 1, further comprising:
outputting a reframed visual media comprising the one or more reframed frames via a graphical user interface corresponding to the display.

3. The method of claim 1,
wherein the cropping window is determined based on significance related to a collated set of at least one object area and is smaller than or equal to a size determined based on at least one of the aspect ratio or the size of the display,
wherein the at least one object area corresponds to the detected one or more features, and
wherein significance of an object area is determined based on at least one of feature size, feature quantity, and feature type in the object area.

4. The method of claim 3, wherein, in case that a plurality of features are detected, the collated set of at least one object area includes at least one merged object area obtained based on a plurality of object area corresponding to the a plurality of features.

5. The method of claim 1, wherein the one or more reframed frames are generated either on-cloud or on-device.

6. The method of claim 1, wherein the cropping window is set to the center cropping of image, or retention of previous cropping windows if no features are detected.

7. The method of claim 1, further comprising:
in case that a change of the aspect ratio is detected, obtaining new one or more reframed frames based on the change.

8. The method of claim 1, wherein, the detection model comprises at least one of a scene boundary detection model, a human and animated cartoon face detection model, an object detection model, or an overlay detection model.

9. An apparatus for processing an image, the apparatus comprising:
at least one memory, comprising one or more storage media, storing instructions; and
at least one processor communicatively coupled to the memory,
wherein the instructions, when executed by the at least one processor individually or collectively, cause the apparatus to:
obtain one or more frames from at least one input visual media,
for at least one frame of the one or more frames, detect one or more features from the at least one frame based on detection model,
determine at least one cropping window based on the one or more detected features and information regarding an aspect ratio of a display,
obtain one or more cropped frames based on the at least one cropping window,
selecting one or more overlays based on one or more cropped out features, text, picture-in-picture display, and spaces left in the display, and
generate one or more reframed frames by situating one or more selected overlays on the one or more cropped frame.

10. The apparatus of claim 9, wherein the instructions, when executed by the at least one processor individually or collectively, further cause the apparatus to:
output a reframed visual media comprising the one or more reframed frames via a graphical user interface corresponding to the display.

11. The apparatus of claim 9,
wherein the at least one cropping window is determined based on significance related to a collated set of at least one object area and is smaller than or equal to a size determined based on at least one of the aspect ratio or the size of the display,
wherein the at least one object area corresponds to the detected one or more features, and
wherein significance of an object area is determined based on at least one of feature size, feature quantity, and feature type in the object area.

12. The apparatus of claim 11, wherein, in case that a plurality of features are detected, the collated set of at least one object area includes at least one merged object area obtained based on a plurality of object area corresponding to the a plurality of features.

13. The apparatus of claim 9, wherein the at least one cropping window is set to the center cropping of image, or retention of previous cropping windows if no significant features are detected.

14. The apparatus of claim 9, wherein, the detection model comprises at least one of a scene boundary detection, a human and animated cartoon face detection, an object detection, or an overlay detection.

15. The apparatus of claim 9, wherein the one or more reframed frames are generated either on-cloud or on-device.

16. The apparatus of claim 9, wherein the instructions, when executed by the at least one processor individually or collectively, further cause the apparatus to:
in case that a change of the aspect ratio is detected, obtain new one or more reframed frames based on the change.

17. One or more non-transitory computer-readable storage media storing one or more computer programs including computer-executable instructions that, when executed by at least one processor of an apparatus individually or collectively, cause the apparatus to perform operations, the operations comprising:
obtaining one or more frames from at least one input visual media;
for at least one frame of the one or more frames, detecting one or more features from the at least one frame based on detection model;
determining at least one cropping window based on the one or more detected features and information regarding an aspect ratio of a display;
obtaining one or more cropped frames based on the at least one cropping window;
selecting one or more overlays based on one or more cropped out features, text, picture-in-picture display, and spaces left in the display; and
generating one or more reframed frames by situating one or more selected overlays on the one or more cropped frame.

18. The one or more non-transitory computer-readable storage media of claim 17, the operations further comprising:
outputting a reframed visual media comprising the one or more reframed frames via a graphical user interface corresponding to the display.
